(19) United States
(12) Patent Application Publication
(10) Pub. No.: US 2020/0349195 A1
(43) Pub. Date: Nov. 5, 2020

(54) File Attribute for Source Inspection

(71) Applicant: Dell Products L.P., Round Rock, TX (US)

(72) Inventors: Mainak Roy, Kolkata (IN); Rathi Babu, Bangalore (IN); Vibha Garg, Bangalore (IN)

(73) Assignee: Dell Products L.P., Round Rock, TX (US)

(21) Appl. No.: 16/401,374

(22) Filed: May 2, 2019

(51) Int. Cl. G06F 16/908; G06F 16/955

(52) U.S. Cl. CPC G06F 16/908; G06F 16/955

(57) ABSTRACT

A system, method, and computer-readable medium are disclosed for improved identification of sources of files. In various embodiments, files are downloaded from one or more locations or sources to a user device. The sources can be local sources to the or on the user device. In certain cases, the sources can be from sites or networks. The files can be part of a software update package. Meta-data extensions are added to the copied files that indicate the source that the files are copied from. In certain implementations, other meta-data extensions are added to the files. The files with meta-data extensions are stored. The files with meta-data extensions can be retrieved when there is a need to determine where the files were originally copied from.

### BACKGROUND OF THE INVENTION

### Field of the Invention

The present invention relates to the management of information handling systems. More specifically, embodiments of the invention provide a system, method, and computer-readable medium for improved identification of sources of files.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When a user downloads a computer file (i.e., file), such as a file to perform a task or provide information, the user may need to download the file again in the future. The user may have forgotten the location or source from which the file was downloaded. For example, a user may download files from different websites, hardware devices (e.g., USB thumb drives, hard disk drives, etc.), and/or networks. A few months later, the user needs to download the files to access the information or update the information; however, the user has forgotten which location or source the files were downloaded from. Identifying the location or source of downloaded files can also be a challenge to others, such as product support groups. For example, when a product support group provides a software update package (SUP), various drivers and applications may be retrieved and downloaded by users from various locations and sources and installed on users' platform. When a particular drivers or applications malfunction, it is desirable to know the locations or sources where users retrieved and downloaded such drivers or applications. Certain web browsers and operating systems may allow the identification of web sites from which files originate; however, such methods typically require that the web browser be in operation to identify a particular web site.

### SUMMARY OF THE INVENTION

A system, method, and computer-readable medium are disclosed for improved identification of sources of files. In various embodiments, files are downloaded from one or more locations or sources to a user device. The sources can be local sources to the or on the user device. In certain cases, the sources can be from sites or networks. The files can be part of a software update package. Meta-data extensions are added to the copied files that indicate the source that the files are copied from. In certain implementations, other meta-data extensions are added to the files. The files with meta-data extensions are stored. The files with meta-data extensions can be retrieved when there is a need to determine where the files were originally copied from.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of a file source identification system;

FIG. 3 is a simplified block diagram of a user device to provide for a file attribute for source inspection;

FIG. 4 is a general flowchart for processing files with meta-data to provide for file attribute for source inspection;

FIG. 5 is a general flowchart for processing an alternate data stream for meta-data when a file is copied from a source; and

FIG. 6 is a generalized flowchart for tracing back malfunctioning software.

### DETAILED DESCRIPTION

A system, method, and computer-readable medium are disclosed for identification of sources of computer files or files. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

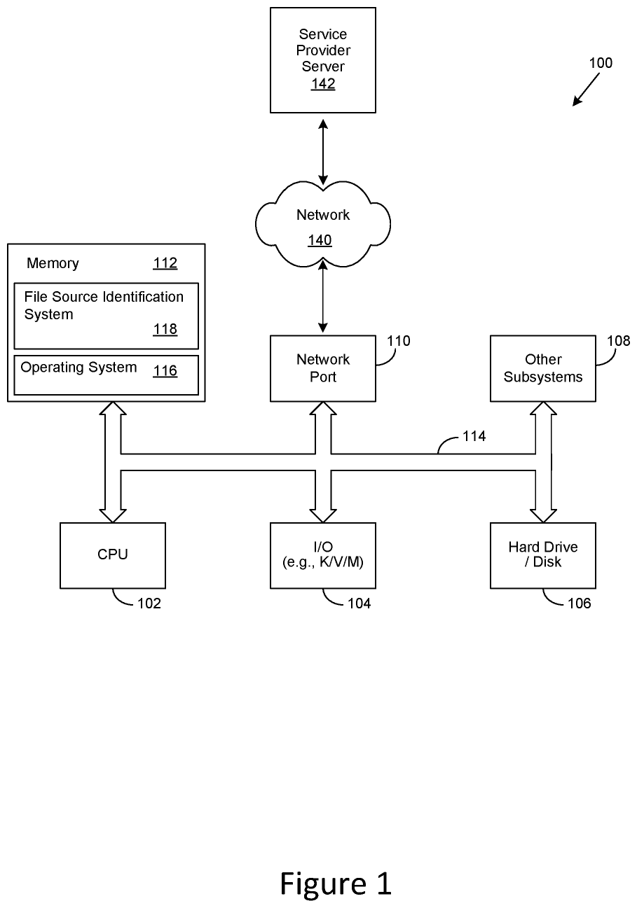

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also include a file source identification system 118. In particular, the file source identification system 118 provides for a file attribute for source inspection. In certain embodiments, the file source identification system 118 is configured to support multiple products and/or services that are provided by different companies, vendors, suppliers, etc. In certain implementations, the file source identification system 118 is provided as a service from the service provider server 142.

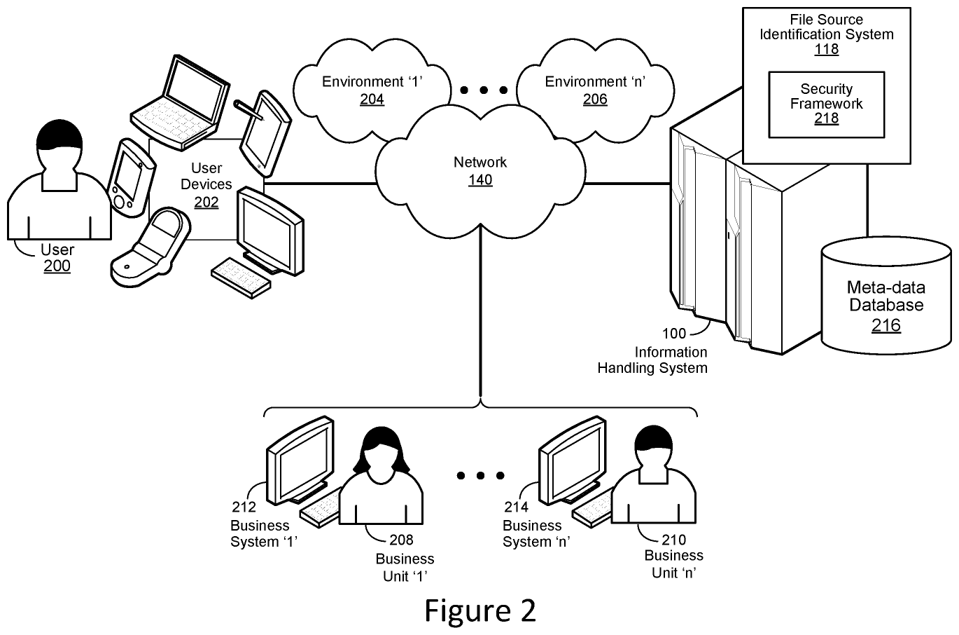

FIG. 2 is a simplified block diagram of a file source identification system 118 implemented in accordance with an embodiment of the invention to provide for a file attribute for source inspection. In various embodiments, user 200 through user device(s) 202 can perform a file attribute for source inspection to identify a location or source from which a file is downloaded/retrieved. User 200 can be representative of multiple users. In certain implementations, file attribute for source inspection can be through file source identification system 118.

As used herein, user device(s) 202 refers to an information handling system such as a personal computer, a laptop computer, a tablet computer, a personal digital assistant (PDA), a smart phone, a mobile telephone, or other device that is capable of communicating and processing data. In various embodiments, the user device(s) 202 is used to exchange information between the information handling system 100 through the use of a network 140. In certain embodiments, the network 140 may be a public network, such as the Internet, a physical private network, a wireless network, a virtual private network (VPN), or any combination thereof. Skilled practitioners of the art will recognize that many such embodiments are possible and the foregoing is not intended to limit the spirit, scope or intent of the invention.

User device(s) 202 are connected to network 140. Furthermore, network 140 can include environment ‘1’ 204 through environment ‘n’ 206. Environment ‘1’ 204 through environment ‘n’ 206 can include various sites, platforms, environments, etc., which provide files. Such files can be downloaded by user device(s) 202 and can include various downloadable objects, such as data or information, including software drivers and applications.

In certain implementations, the user 200 can interact with one or more business units, as represented by business unit ‘1” 208 through business unit ‘n’ 210. Communication by business unit 1″ 208 through business unit ‘n’ 210 can be through network 140 through respective business system ‘1’ 212 through business system ‘n’ 214. In certain implementations, by business unit 1″ 208 through business unit ‘n’ 210 can be administrators of file source identification system 118.

In certain implementations, the business unit 1″ 208 through business unit ‘n’ 210 can include product support or customer support units, such as information technology (IT) administrators, that provide assistance to user 200. For example, a product support unit can provide update packages, such as software update packages (SUP). Along with the SUP, a listing of items, parts, etc. can be included (SWB). The product support unit or IT group can track the SUP and SWB. In particular, through file source identification system 118, installed files from particular SUPs at user device(s) 202 can be tracked. Such installed files can include meta-data that provide a file attribute for source inspection. For example, in the event a driver or application fails, by identifying the SUP and source (e.g., website uniform resource locator or URL) through the meta-data of the files, a link can be established to the installed software and problematic SUP and SWB.

In certain implementations, downloaded and installed files can include meta-data that describes “file source” or “file origin”, “identifier of the source/origin”, “download count”, “size”, “image location”, “SUP name”, “SUP path/download path”, etc. Certain implementations can further include meta-data related to “download count” to avoid multiple downloads for the same file for different systems. For certain implementations, the files with meta-data can reside in an installation folder made available, when user 200 installs a SUP on user device(s) 202. In certain implementations, meta-data can provide for an alternate data stream or extended attributes, where a SUP and SWB, along with the downloaded URL are added to a folder and files when the SUP is installed on a user device 202 platform.

In certain embodiments, a meta-data database 216 is included with the information handling system 100. The meta-data database 216 can include meta-data related information such as SUP folders, files with meta-data, etc.

In certain implementations, the information handling system 100 includes a security framework 218. The security framework 218 can provide a utility to parse user 200 downloaded files, and stores/adds the meta-data to the files. When user 200 attempts to download a file, the security framework 218 can check the files and meta-data and alert a business system ‘1’ 212 through business system ‘n’ 214, such as an information technology (IT) administrator.

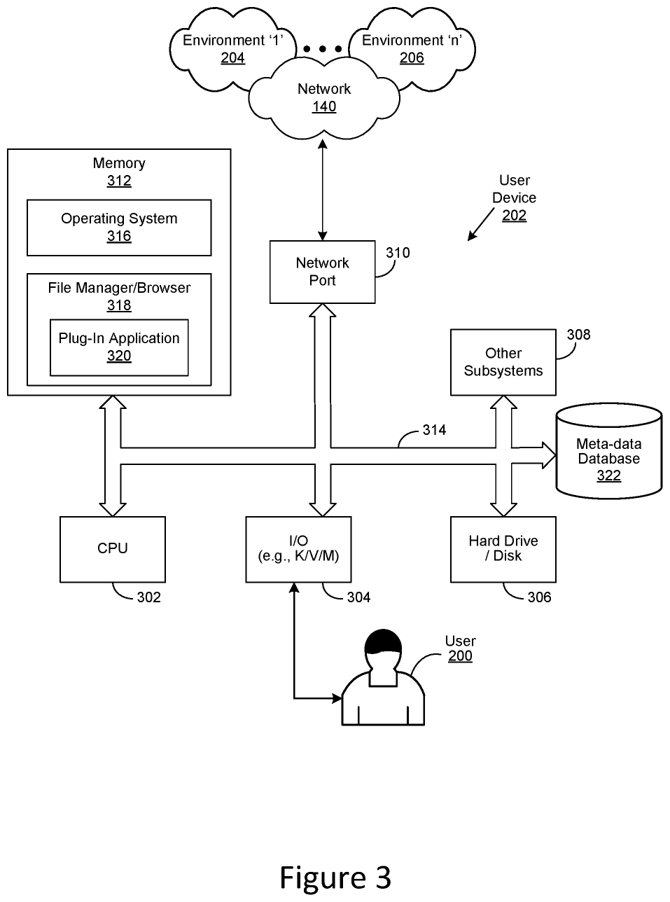

FIG. 3 is a generalized illustration of user device 202 that can be used to implement the system and method of the present invention. The user device 202 includes a processor (e.g., central processor unit or “CPU”) 302, input/output (I/O) devices 304, such as a microphone, a keyboard, a video/display, a mouse, and associated controllers (e.g., K/V/M), a hard drive or disk storage 306, and various other subsystems 308. User 200 can interact with the user device through I/O devices 304.

In various embodiments, the user device 202 also includes network port 310 operable to connect to the network 140, which is likewise accessible by service provider server 142. As discussed, the network 140 can include environment ‘1’ 204 through environment ‘n’ 206. Environment ‘1’ 204 through environment ‘n’ 206 can include various sites, platforms, environments, etc., which provide files are retrieved and downloaded (i.e., copied from).

I/O devices 304 can include various USB and connected local sources (e.g., SD cards, scanners, digital cameras, etc.), from which files are retrieved and downloaded. The hard drive or disk storage 306 can also be a source from which files are retrieved and downloaded. Other subsystems 308 can also include sources from which files are retrieved and downloaded. In certain implementations, the user device 202 can be connected to a network file system (NFS) or cluster file system (NFS), which can be sources from which files can be retrieved and downloaded.

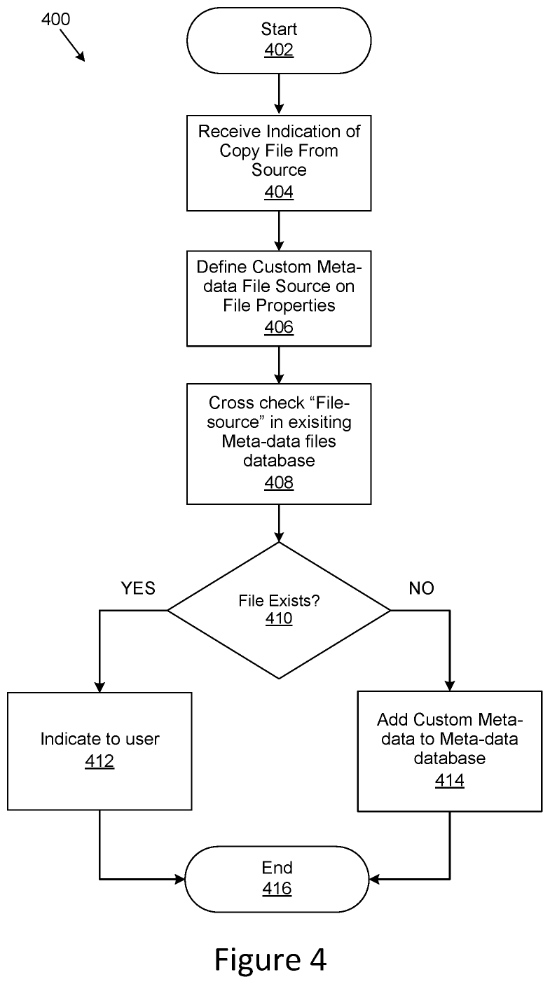

The user device 202 likewise includes system memory 312, which is interconnected to the foregoing via one or more buses 314. System memory 312 can further comprise operating system (OS) 316 and in various embodiments can also include a file manager or file browser 318. In certain implementations, the file manager or file browser 318 includes a plug-in application 320. The plug-in application 320 is further described below in reference to FIG. 4. In certain implementations, the plug-in application 320 can be configured such that when software (e.g., through a SUP) is installed, an installation folder is created which includes installed files. Through the implementation of the plug-in application 320 meta-data or meta-data extensions can be added to the files that can include “file source” or “file origin.” Such meta-data provide file attributes (i.e., the meta-data) for source inspection.

Files with meta-data extensions can be placed in folders. In certain implementations, the user device 202 can include a meta-data database 322 which stores files with meta-data extensions, and folders that include files with meta-data extensions. When needed user device 202 can access such files with meta-data extensions and determine which location or source particular files are downloaded from (i.e., copied from). In certain, implementations, the file manager or file browser 318 is configured to read the files with meta-data extensions and determine the location or source from which the files were downloaded from (i.e., copied from).

FIG. 4 is a generalized flowchart 400 for processing files with meta-data to provide for file attribute for source inspection. In certain implementations the process 400 can be performed by a plug-in application resident on the user device 200. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 402 the process 400 starts. At step 404, an indication is received that a user device is copying a file (i.e., retrieving or downloading) a file (i.e., computer file) from a particular source. The source can include local sources as described above. At step 406, meta-data as to file source is defined for the file that is copied. Such meta-data extension as to file source can be added to the copied file. At step 408, a determination or cross check is performed as to whether the particular file has been copied before and exists in a database (i.e., meta-data database 322). If the file exists, following the YES branch of block 410, at step 412, and indication is provided to the user (i.e., user 200) that the file exits. Otherwise, if the file does not exists, following the NO branch of block 410, at 414 the meta-data as to file source or file origin is added to the copied file to create a file with meta-data extension, and the file with the meta-data extension can be stored or added to a databased (i.e., meta-data database 322). At block 414, the process 400 ends.

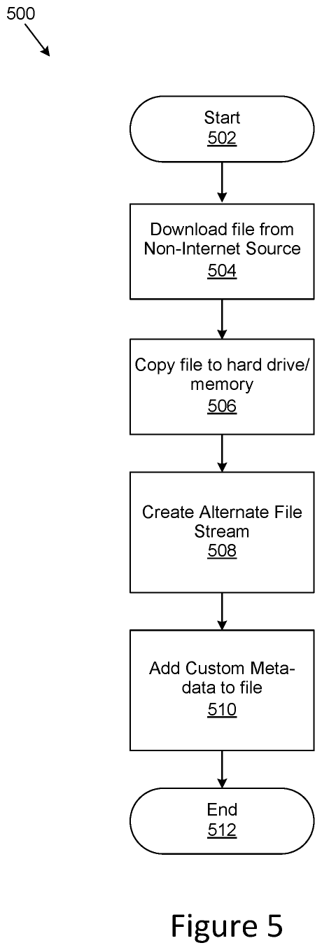

FIG. 5 is a generalized flowchart 500 for processing/providing an alternate data stream for meta-data when a file is copied from a source. For example, the source can be a universal serial bus (USB) drive, secure data (SD) card, compact disc (CD), file share, scanner, etc. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 502 the process 500 starts. At step 504, a user downloads a file (i.e., computer file) that can contain information or data, from a local source or non-Internet or website source. Typically, when the file is copied to a hard disk/drive or other storage device (e.g., memory device), the path name to the file is directed to that hard disk or other storage device. At step 506, the file is copied to hard drive/memory or the hard disk/drive or other storage device (e.g., memory device). At step 508, meta-data is created as to an alternate file stream or path, where the meta-data or meta-data extension provides information as to “file source” or “file origin.” At block 510, the meta-data extension is added to the copied file. At block 512, the process 500 ends.

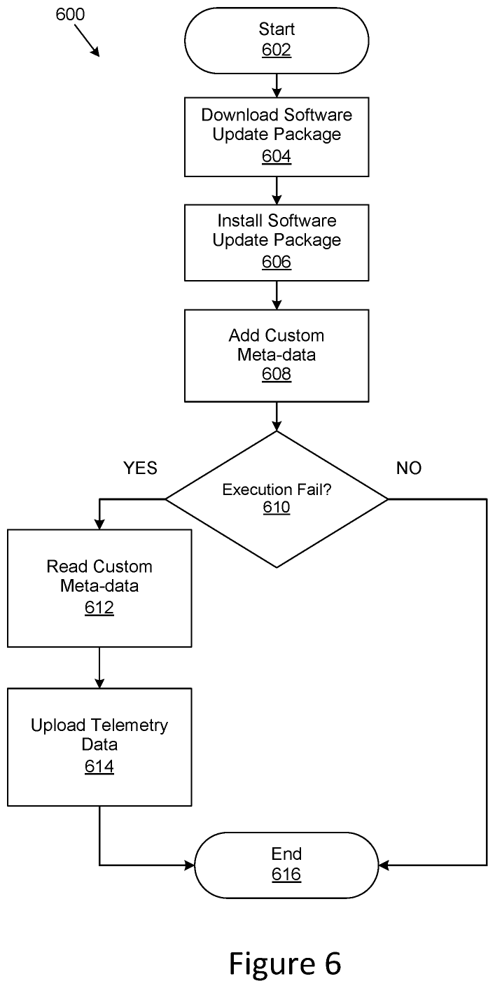

FIG. 6 is a generalized flowchart 600 for processing/providing tracing back a malfunctioning software (i.e., file) to a software update package (SUP) and item list (SWB). The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 602 the process 600 starts. At step 604, downloading of files or software is performed, such as through a software update package (SUP). The files in the SUP can be downloaded from various sources. The sources of the software are identified. At block 606, the software update package (SUP) is installed on a user device (e.g., user device 202). In certain implementations, a parts list or SWB can be included with the SUP. At block 608, meta-data extensions are added to the installed files of the SUP. Each file can include meta-data extensions such as “file source” or “file origin”, “identifier of the source/origin”, “download count”, “size”, “image location”, “SUP name”, “SUP path/download path”, etc. In the event execution of the SUP fails, following the YES branch of block 610, then at step 612 the meta-data extensions of the files are read. In certain implementations, a business unit such the business unit 1″ 208 through business unit ‘n’ 210 can provide a service to the user 200 as to troubleshooting the installed SUP. The business unit can include information technology (IT) administrators that assist user 200. At block 614, telemetry data is uploaded. In particular, the telemetry data includes the files with the meta-data extensions, that include information as to the SUP and SWB. Such telemetry data can allow the business unit or IT administrator to trouble shoot the SUP. At block 616, the process 600 ends. If the SUP does not fail, following the NO branch of block 610, the process 600 ends.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for identification of sources of files comprising:
downloading one or more files from one or more sources;
determining the source from which the files are downloaded;
adding meta-data extensions to the downloaded files as to the one or more sources, to create files with meta-data extensions; and
storing the files with meta-data extensions.

2. The method of claim 1, wherein the downloading is from the one or more sources is from local device locations.

3. The method of claim 1, wherein the one or more files are part of a software update package (SUP).

4. The method of claim 4, wherein files in the software update package (SUP) are from one or more different locations.

5. The method of claim 1, wherein the meta-data extensions further comprise information related to one or more of: file source, file origin, identifier of the source/origin, download count, size, image location, software update package (SUP), software update package (SUP) path/download path.

6. The method of claim 1 wherein the storing is performed on a dedicated meta-data database that includes folders of the files with meta-data extensions.

7. The method of claim 1 further comprising providing an alternative data stream as part of a meta-data extension when files are copied from the one or more sources.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for improved management of unattended user queries and comprising instructions executable by the processor and configured for:
downloading one or more files from one or more sources;
determining the source from which the files are downloaded;
adding meta-data extensions to the downloaded files as to the one or more sources, to create files with meta-data extensions; and
storing the files with meta-data extensions.

9. The system of claim 8, wherein the downloading is from the one or more sources is from local device locations.

10. The system of claim 8, wherein the one or more files are part of a software update package (SUP).

11. The system of claim 10, wherein files in the software update package (SUP) are from one or more different locations.

12. The system of claim 8, wherein the meta-data extensions further comprise information related to one or more of: file source, file origin, identifier of the source/origin, download count, size, image location, software update package (SUP), software update package (SUP) path/download path.

13. The system of claim 8, wherein the storing is performed on a dedicated meta-data database that includes folders of the files with meta-data extensions.

14. The system of claim 8 further comprising providing an alternative data stream as part of a meta-data extension when files are copied from the one or more sources.

15. A non-transitory, computer-readable storage medium embodying computer program code, the computer program code comprising computer executable instructions configured for:
downloading one or more files from one or more sources;
determining the source from which the files are downloaded;
adding meta-data extensions to the downloaded files as to the one or more sources, to create files with meta-data extensions; and
storing the files with meta-data extensions.

16. The non-transitory, computer-readable storage medium of claim 15, wherein the downloading is from the one or more sources is from local device locations.

17. The non-transitory, computer-readable storage medium of claim 15, wherein the one or more files are part of a software update package (SUP).

18. The non-transitory, computer-readable storage medium of claim 17, wherein files in the software update package (SUP) are from one or more different locations.

19. The non-transitory, computer-readable storage medium of claim 15, wherein the meta-data extensions further comprise information related to one or more of: file source, file origin, identifier of the source/origin, download count, size, image location, software update package (SUP), software update package (SUP) path/download path

20. The non-transitory, computer-readable storage medium of claim 15 further providing an alternative data stream as part of a meta-data extension when files are copied from the one or more sources.
